(19) United States
(12) Patent Application Publication
(10) Pub. No.: US 2008/0196780 A1
(43) Pub. Date: Aug. 21, 2008

(54) Fuel Reservoir With Integrally Molded Valve

(75) Inventors: Larry Tipton, Sterling Heights, MI (US); Paul Daniel Reuther, Oxford, MI (US)

Correspondence Address: OBLON, SPIVAK, MCCLELLAND MAIER & NEUSTADT, P.C., 1940 DUKE STREET, ALEXANDRIA, VA, 22314, US

(73) Assignee: INERGY AUTO SYSTEMS RESEARCH (SOCIETE ANONYME), Brussels (BE)

(21) Appl. No.: 11/908,543

(22) PCT Filed: Mar. 13, 2006
(86) PCT No.: PCT/EP06/60653

§ 371 Date: Mar. 6, 2008

Related U.S. Application Data
(60) Provisional application No. 60/661,406, filed on Mar. 14, 2005.

(51) Int. Cl. B60K 15/077

(52) U.S. Cl. 137/861

(57) ABSTRACT

Fuel reservoir having a bottom (5) and a valve integrally molded with said bottom and comprising:—a disk or flap (1) having a hole (2) in it;—at least one post (3) that fits through the hole (2) in the disk and which is integrally molded with the reservoir's bottom (5); and—at least one hole (4) through the reservoir's bottom (5) which is positioned close to the post (3) and in a way such that the disk (1) covers it when positioned in its relief position.

To date, fuel delivery modules (FDM) require a substantial reservoir capacity to provide enough reserve fuel for low fuel considerations.

It is namely so that in certain circumstances, for example, when the volume of fuel contained in the fuel tank of an automotive vehicle falls below a certain minimum level and this vehicle travels through a prolonged curve, uphill or downhill, or if it is otherwise subjected to sudden and pronounced changes in speed, direction, etc., the fuel could be displaced to one side of the tank to such an extent that the inlet end of the dip tube, which forms part of the fuel-intake tubing, is at least temporarily no longer submerged in the fuel. Under such conditions, the dip tube sucks out air instead of fuel, thereby producing an interruption in the feed fuel flow that impedes the proper operation of the internal-combustion engine.

In order to avoid such problems, most fuel tanks include a reservoir i.e. a subtank intended to trap fuel and act as a reserve. To perform this function, conventional fuel reservoirs are equipped with a first fill valve i.e. a one way check valve mounted in the bottom of it and allowing fuel into the bottom of the reservoir, but not allowing fuel out. This allows the reservoir to fill passively as the tank is filled, while keeping fuel from leaving the reservoir during low fuel conditions. This device is a necessary component in a conventional fuel module reservoir. Reducing the cost of this device is the problem this invention aims to solve.

There are several designs known for the above mentioned first fill valves. Some of them use a disk to respectively open/close apertures in the reservoir's bottom, and an additional component, such as a cage, to trap the disk on top of the holes. This cage is an additional part that has to be welded in place. Another known design option is those of umbrella style valves. However, such valves tend to be more expensive than disk valves and there have been issues in the past with sealing at low fuel levels after durability.

To this end, the present inventions concerns a new design for a disk valve, which is very simple, reliable and non expensive.

Hence, the present invention concerns a fuel reservoir having a bottom and a valve integrally molded with said bottom and comprising:
a disk or flap having a hole in it;
a post that fits through the hole in the disk and which is integrally molded with the reservoir's bottom; and
at least one hole through the reservoir's bottom which is positioned close to the post and in a way such that the disk covers it when positioned in its relief position.

Preferably, there are several such holes surrounding the post.

The essential feature of said design resides in the fact that the disk is retained in the reservoir, on top of the hole(s), through at least one post (pin) which is integrally molded with the reservoir's bottom. There could be one or several post(s) which could either extend through corresponding holes in the disk or could grip said disc like fingers.

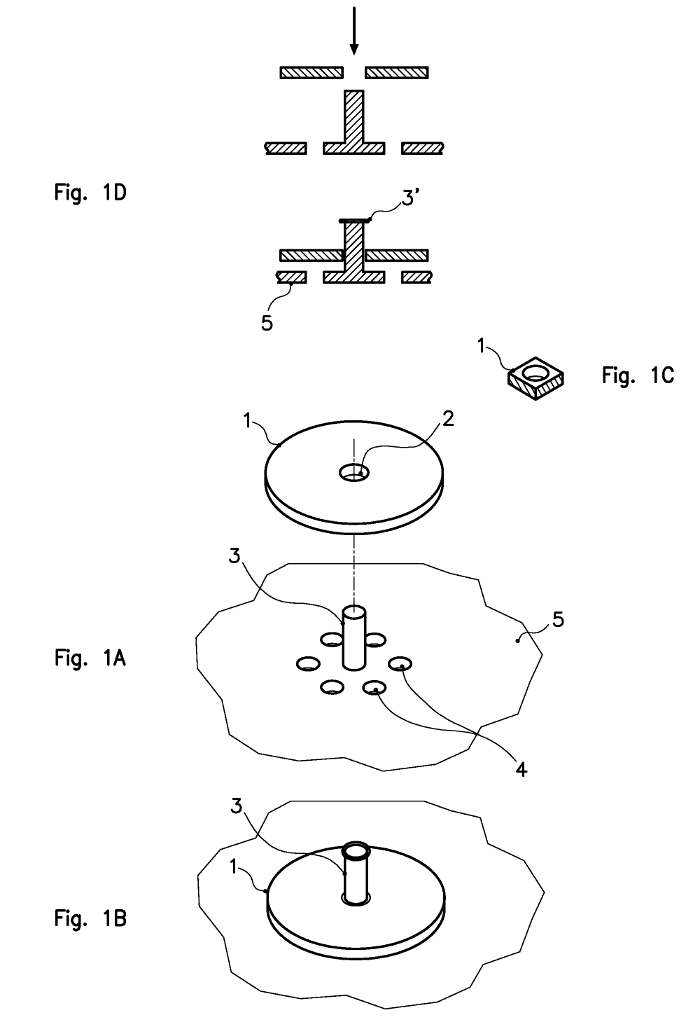

Preferred embodiments of the invention are pictured in FIGS. 1 to 4, which show the following:

FIGS. 1A and 1B: on embodiment of the basic concept, wherein the tank bottom (5) comprises 6 holes (4) surrounding a post (3) intended to be fitted through a hole (2) of the disk (1);

FIG. 1C: a variant of the disc shown in FIGS. 1A and 1B, said disc being of squared shape;

FIG. 1D: the way of fixing the disc to go from FIG. 1A to FIG. 1B;

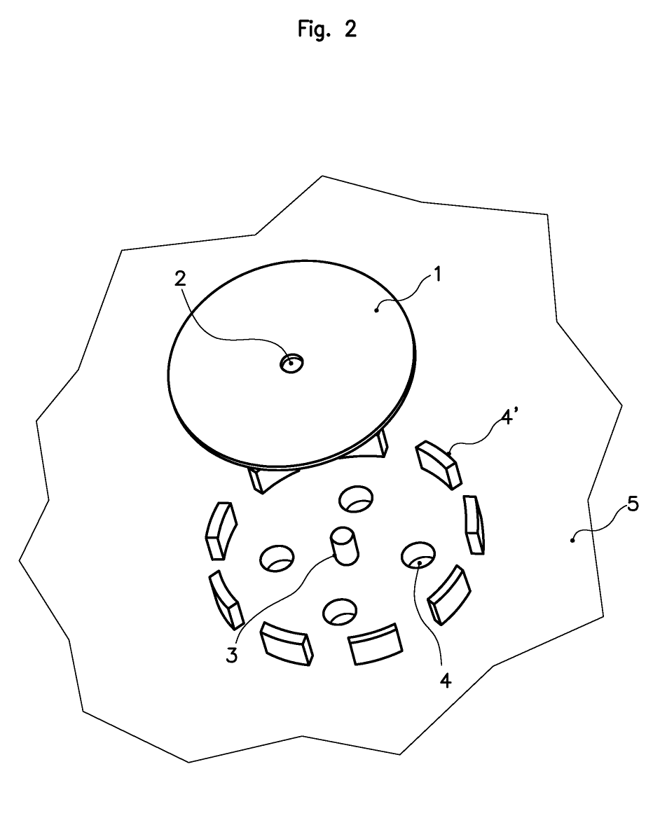

FIG. 2: a variant with 4 holes (4) and a surrounding stair (4′) comprised of an interrupted wall (or several posts);

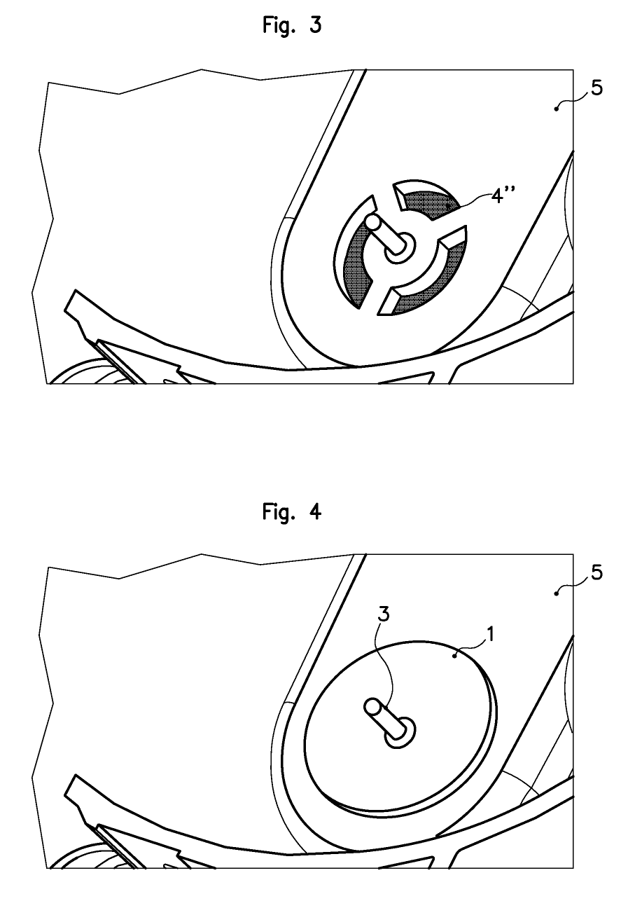

FIGS. 3 and 4: a variant with 3 holes (4) in the shape of slots defining an interrupted annular hole (4″).

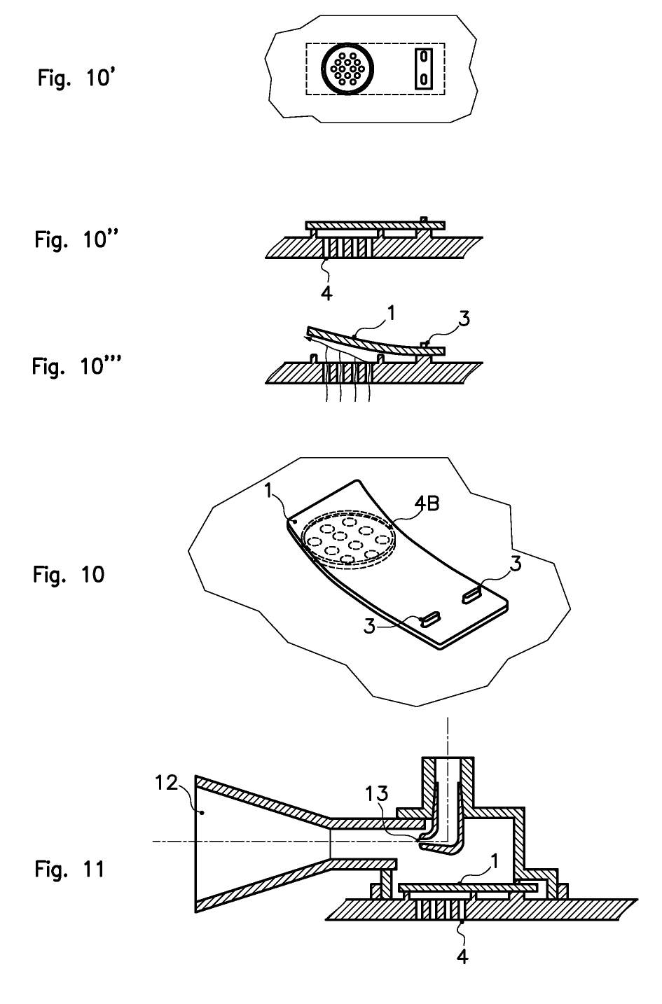

They are all characterized by the presence of the following components:
A piece of material (1, called a disk, although it might be in the shape of a square like in FIG. 1C, or of a rectangular shape like in FIG. 10) with a hole (2) in it, which may be in its center (like in most of the pictured embodiments), on the side (periphery) of it (as in FIG. 10), or any where else.
At least one post (3) that fits through the hole in the disk (1).
Several holes (4) through the reservoir's bottom (5) which are positioned around (in the neighborhood of) the post (3) and in a way such that the disk (1) covers them when positioned with the post (3) inside its hole (2) and when is in its relief position (no pressure lifting the disk). These holes (4) may be of any shape: circular (like in FIGS. 1 and 2), or in the shape of slots (like in FIGS. 3 and 4).

As mentioned above, the post is integrally molded with the tank reservoir and is thus of the same material, while the disk may be of another material. Polyacetals, and in particular, polyoxymethylene (or POM) gives good results for the reservoir, while elastomers and in particular, fluorosilicone gives good results for the sealing disk.

Several techniques are available for fixing the disk on the post.

According to one of them (illustrated in FIG. 1D), the disk is first assembled to the post and then the post is distorted or another piece (3′) is put on top of the post, such that the disk is trapped underneath.

An alternative is to have the disk of an elastic material and have an expansion in the diameter in the distal end of the post. The hole in the disk would be smaller than the diameter at the end of the post. The hole in the disk would then temporarily stretch over the distal end of the post and in that way be retained to the post.

In both cases, the post has a diameter smaller that the diameter of the hole in the disc on its entire length but has a distal end with a diameter larger than the one of the hole in the disk. In fact, the “diameter” concept may be generalized to holes/distal ends other than circular ones so that in fact, the sections (of the hole and the post) merely have to be such that they either block or allow the passage of the post though the hole.

According to a preferred embodiment, the bottom of the reservoir is provided with a relief/design enabling the tight sealing of the reservoir when the disk lies on the bottom. Good results have been obtained when providing a sealing bead surrounding the post and/or around the underside perimeter of the disk and/or around the holes in the bottom of the reservoir.

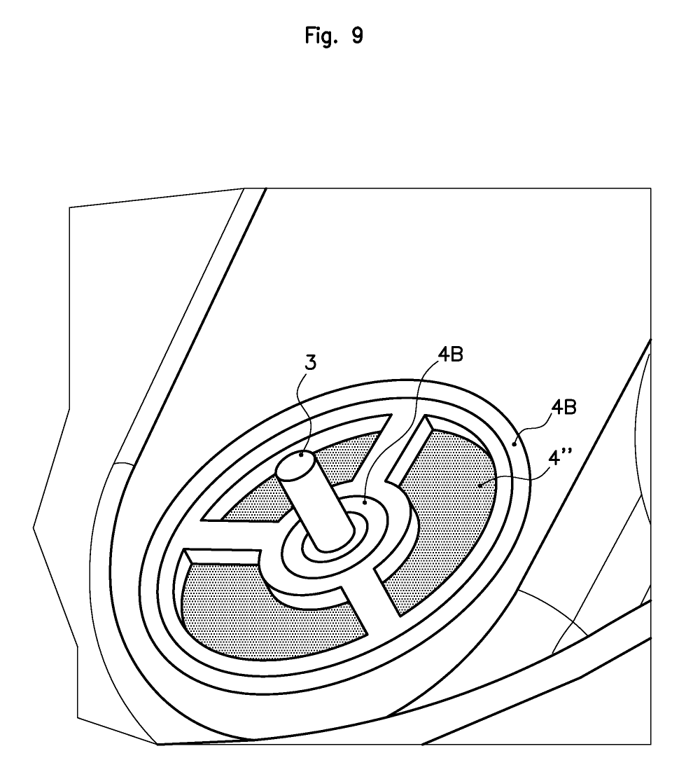

In the case of a circular disk, 2 circular sealing beads (4b, as pictured in FIG. 9 for instance) are effective in reducing the amount of leakage through the valve interface. When the valve is in its relief position, the disk rests on said beads (generally of circular and even, concentric form). It is worth noting that said sealing beads may be located on the disk instead of on the reservoir bottom.
In the case of a disk of rectangular shape, only one sealing bead (4b) may be enough: see FIG. 10 for instance.

With the design of FIGS. 1, 3 and 4, there can be a problem if the pump strainer (or another component) covers the disk, since then the disk would not be allowed too lift and would block the holes and preventing fuel from entering into the reservoir.

Accordingly, in a preferred embodiment (pictured in FIG. 2), the holes are surrounded by a “wall” (kind of stair) with slots cut into it and which has a diameter beyond the diameter of the disk so that the disk can move (slide) into it. This stair (wall) is high enough to prevent something (like the fuel strainer) from covering the disk from the top. If the top of the wall is covered by the strainer, the slots will still allow flow to travel from the holes in the bottom of the reservoir to around the periphery of the wall when the disk is lifted.

According to another embodiment, the reservoir according to the invention is filled through a jet pump (i.e. a device comprising a tube ending with an orifice through which a flow passes which generates a depression by Venturi effect). This jet pump sucks fuel from the fuel tank outside the reservoir through the holes of the disk valve.

According to a preferred embodiment, this jet pump is in one piece with a housing (into which it actually ends) which also integrates a mixing tube and which covers the disc valve. More preferably, the jet pump is also integrated in a one piece connector which is the object of a co-pending application. This piece preferably has the form of a “T” with 3 branches, 2 of them being connected respectively to a main fuel pump and to a fuel filter and the third one integrating the jet pump. The orifice of the jet pump is preferably located right in front of the entrance of the mixing tube. By doing so, the fuel flow coming from the fuel pump blows right into the entrance of the mixing tube and entrains fuel from the fuel tank though the holes of the valve according to the invention.

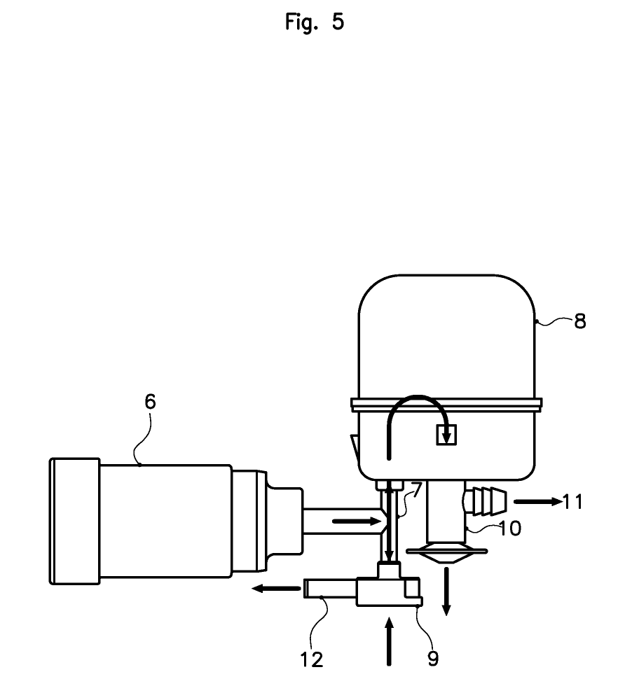

This embodiment (and several preferred features thereof) is illustrated in a non limitative way by FIGS. 5 to 8, and 11. In all figures, identical numbers designate similar or identical parts.

FIG. 5 shows how a main fuel pump (6) discharges into a “T” connector (7) a fuel flow which is split into a flow to a fuel filter (8) and a flow to a jet pump orifice integrated in a housing (9) molded in one piece with the “T”. The fuel exits the fuel filter (8) through a pressure regulator (10) which routes the required amount of fuel to an engine (11, not pictured) and returns the rest to the reservoir. The jet pump integrated in the housing (9) sucks fuel from the fuel tank through an integrally molded valve according to the invention (not pictured) and a mixing tube (12) discharges into the reservoir, a mixed flow of fuel coming from the pump (6) on one side (through the “T” (7) and the jet pump) and from the fuel tank (through the integrally molded valve) on the other side.

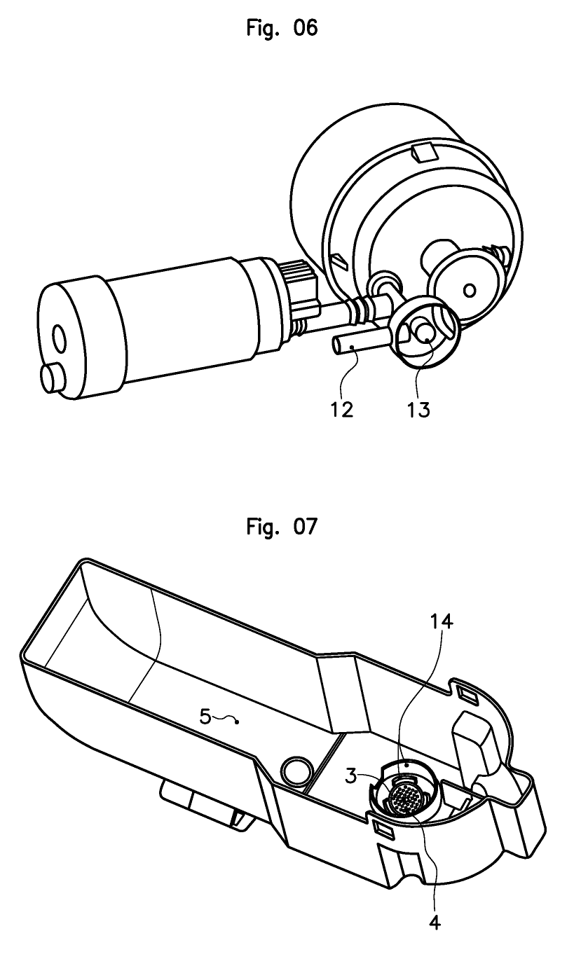

FIG. 6 shows the same assembly but viewed from underneath to illustrate how the small jet pump orifice (13) blows right into the mixing tube (12), entraining fuel from the fuel tank.

FIG. 7 shows the bottom (5) of the reservoir wherein the system of FIGS. 5 and 6 is intended to be mounted. This bottom (5) comprises an integrally molded disk valve according to the invention which is surrounded by a perimeter wall (14). This valve comprises a rubber disk (not shown) which:
is maintained by a post (3);
is opened by fuel being drawn into the holes (4) of the bottom of the reservoir by the jet flow; and
which seals said holes (4) when the jet flow stops to retain reservoir capacity.

This valve eliminates the need for the check valve in the pump outlet to prevent fuel from siphoning out of the reservoir.

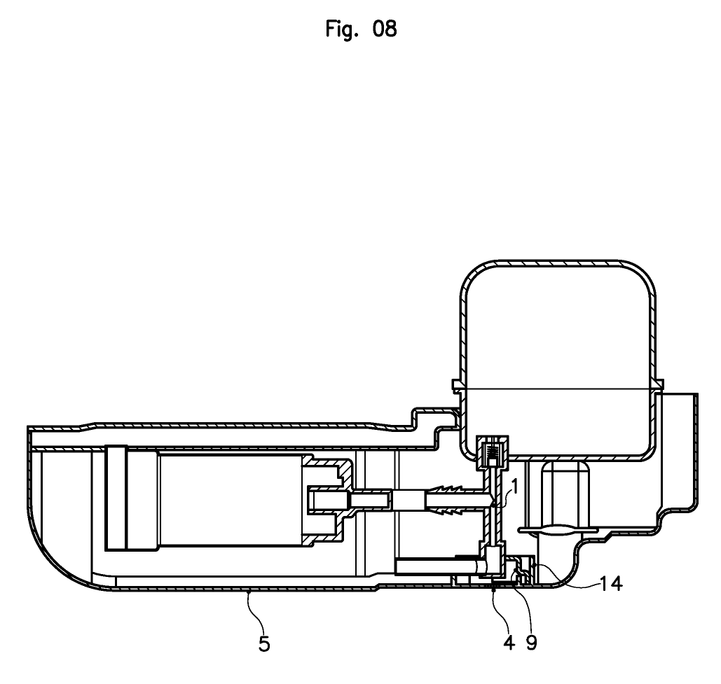

FIG. 8 shows a longitudinal cut into the system assembled in the reservoir and shows the holes (4) into the bottom of it, holes through which fuel can be sucked from the fuel tank where the reservoir is located (not shown). In this assembly, the housing (9) integrating the jet pump (13) presses into the perimeter wall (14) of the reservoir bottom (5) to function as a partial seal to allow the jet flow to draw fuel through the floor of the reservoir rather than recirculation of the fuel inside the reservoir.

FIGS. 10 and 11 show the embodiment according to which a rectangular disk (1) is fixed on its side by 2 posts (3). It has the following advantages over the circular disk with one central post pictured in the other figures:
only one sealing bead (4b) is required;
the walls (4′) required to prevent the disk (1) from becoming uncentered are eliminated; these walls (4′) may hinder the incoming fuel flow;
it works well in conjunction with a jet pump (13) sucking fuel from the fuel tank outside the reservoir through the holes (4) of the valve (as pictured in FIG. 11). The method of securing the disk (flap) (1) itself may reduce the amount of pressure drop caused by the valve itself when the jet pump (13) is operating.

1. A fuel reservoir having a bottom and a valve integrally molded with said bottom and comprising:
a disk or flap having a hole in it;
at least one post that fits through the hole in the disk and which is integrally molded with the reservoir's bottom; and
at least one hole through the reservoir's bottom which is positioned close to the post and in a way such that the disk covers it when positioned in its relief position.

2. The fuel reservoir according to claim 1, wherein there are several holes in the bottom of the reservoir.

3. The fuel reservoir according to claim 1, wherein the disk is in elastomeric material.

4. The fuel reservoir according to claim 3, wherein the post has a diameter smaller that the diameter of the hole on its entire length but has a distal end with a diameter larger than the one of said hole.

5. The fuel reservoir according to claim 1, said reservoir's bottom comprising a sealing bead surrounding the post and/or around the underside perimeter of the disk and/or around the holes in the bottom of the reservoir, so that the disk rests on said beads when the valve is in its relief position.

6. The fuel reservoir according to claim 1, wherein the disk is circular and wherein the hole(s) through the reservoir's bottom is(are) surrounded by a wall with slots cut into it and which has a diameter beyond the diameter of the disk so that the disk can move into it.

7. The fuel reservoir according to claim 1, wherein the disk is rectangular and is fixed on its side by 2 posts.

8. The fuel reservoir according to claim 1, said reservoir comprising a jet pump capable of filling it by sucking fuel from outside through the holes of the disk valve.

9. The fuel reservoir according to claim 8, wherein the jet pump is in one piece with a housing which also integrates a mixing tube and which covers the disc valve.

10. The fuel reservoir according to claim 9, wherein the jet pump is also integrated in a one piece connector having the form of a “T” with 3 branches, 2 of them being connected respectively to a main fuel pump and to a fuel filter and the third one integrating the jet pump and wherein the jet pump comprises a tube having an outlet orifice located right in front of the entrance of the mixing tube.
